(19) United States
(12) Patent Application Publication
(10) Pub. No.: US 2024/0403682 A1
(43) Pub. Date: Dec. 5, 2024

(54) NANOFIBER QUANTUM COMPUTING SYSTEM AND RELATED METHOD

(71) Applicant: Nanofiber Quantum Technologies, Inc., Tokyo (JP)

(72) Inventors: Akihisa GOBAN, Tokyo (JP); Shinya KATO, Tokyo (JP); Ryotaro INOUE, Tokyo (JP); Takao AOKI, Tokyo (JP)

(21) Appl. No.: 18/325,901

(22) Filed: May 30, 2023

(51) Int. Cl. G06N 10/40; G06V 20/69; G21K 1/00

(52) U.S. Cl. CPC G06N 10/40; G06V 20/693; G21K 1/006; G02B 6/4214; G02B 6/4215

(57) ABSTRACT

In an example, the present invention provides a quantum computer cell system. The system has a fiber optical cable. In an example, the system has a nanofiber region configured from a center portion of the fiber optic cable and coupled between a first fiber Bragg Grating and a second fiber Bragg Grating. In an example, the system has a first taper region configured from a first portion of the nanofiber region within a vicinity of the first fiber Bragg Grating and a second taper region configured from a second portion of the nanofiber region within a vicinity of the second fiber Bragg Grating. The system has a plurality of atoms evanescently coupled to the nanofiber region. The system has an imaging system configured to generate an optical tweezer array and to detect one or more photons from one or the plurality of atoms.

### BACKGROUND OF INVENTION

The present invention relates generally to quantum computing techniques. In particular, the present invention provides a system and method including a nanofiber cavity Quantum Electrodynamics (QED) system configured an optical cable including a nanofiber region and a pair of reflectors and evanescently coupled atoms to the nanofiber region to enable an atom-cavity system for a quantum computing device. Merely by way of example, the invention can be applied to a variety of applications such as cryptography, drug discovery, optimization, machine learning and artificial intelligence, finance, weather forecasting, chemical, mechanical, electrical, civil, nuclear fusion and fission, economics, materials, and any other complex human or non-human matters.

Quantum computing is a type of computing that utilizes quantum mechanics to perform certain tasks more efficiently than classical computing. In classical computing, bits can exist in one of two states, either 0 or 1, but in quantum computing, qubits can exist in a superposition of both 0 and 1 states simultaneously. This allows quantum computers to perform certain calculations exponentially faster than classical computers, such as factorization of large numbers, optimization problems, and simulations of quantum systems.

However, quantum computing also has some drawbacks. One major challenge is that qubits are highly susceptible to noise and decoherence, which can cause errors in the computation. Therefore, quantum computers require careful error correction techniques to maintain the accuracy of the computation. Practically useful fault-tolerant quantum computation requires more than millions of qubits, which is beyond the scope of the existing platforms of quantum computations due to the limited capacity of qubit number per single quantum computing device. Towards scalable quantum computation, the quantum computing devices requires both improved capacity per quantum computing device and capability of interconnection among distant quantum computing devices using optical fiber network.

From the above, it is seen that platforms and techniques for connectable quantum computing devices are desired.

### SUMMARY OF INVENTION

According to the present invention, techniques generally related to quantum computing are provided. In particular, the present invention provides a system and method including a nanofiber cavity QED system configured using an optical cable including the nanofiber region and a pair of reflectors and evanescently coupled atoms to the nanofiber region to enable an atom-cavity system for a quantum computing device. Merely by way of example, the invention can be applied to a variety of applications such as cryptography, drug discovery, optimization, machine learning and artificial intelligence, finance, weather forecasting, chemical, mechanical, electrical, civil, nuclear fusion and fission, economics, materials, and any other complex human or non-human matters.

In an example, the present invention provides a quantum computer cell system. In an example, the system has a fiber optical cable having a first end region and a second end region. The first end region has a first end, and the second end region having a second end. In an example, the system has a first fiber Bragg Grating configured on the first end region and a second fiber Bragg Grating configured on the second end region. In an example, the system has a nanofiber region configured from a center portion of the fiber optic cable and coupled between the first end region and the second end region. In an example, the system has a first taper region configured from a first portion of the nanofiber region within a vicinity of the first fiber Bragg Grating and a second taper region configured from a second portion of the nanofiber region within a vicinity of the second fiber Bragg Grating. In an example, the system has a cavity formed between the first fiber Bragg Grating and the second fiber Bragg Gratings including the taper regions and the nanofiber region. In an example, the system has a plurality of atoms evanescently coupled to the nanofiber region between the first fiber Bragg grating and the second fiber Bragg grating. In an example, the system has an imaging system configured to generate an optical tweezer array and to detect one or more photons from one or the plurality of atoms with a spatial resolution ranging from 400 nanometer and larger, but can include variations.

Depending upon the example, the present invention can achieve one or more of these benefits and/or advantages. In an example, the present invention provides a quantum computing device using a nanofiber cavity QED system configured with an optical cable including the nanofiber region and a pair of reflectors, and evanescently coupled atoms to the nanofiber region to form an atom-cavity system for a quantum computing. In an example, the device uses conventional optical techniques, and is compact and efficiently integrated by using fiber optic devices. In an example, the present invention offers advantages of both stationary and flying qubits by utilizing atoms and photons that are suitable for long-distance quantum communication and efficient interconnection among distant quantum computing cells. In a preferred example, the present system allows for control of individual atoms one by one using the present imaging system. These and other benefits and/or advantages are achievable with the present device and related methods. Further details of these benefits and/or advantages can be found throughout the present specification and more particularly below.

A further understanding of the nature and advantages of the invention may be realized by reference to the latter portions of the specification and attached drawings.

### BRIEF DESCRIPTION OF FIGURES

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified diagram illustrating a quantum computing cell device according to an example of the present invention.

FIG. 2 is a simplified illustration of a method of operating a quantum computing cell device according to an example of the present invention.

FIG. 3 is a simplified diagram of a vacuum chamber configured with a quantum computing cell device according to an example of the present invention.

FIG. 4 is a simplified diagram of an optical tweezer device using a standing wave disposed in a nanofiber region according to an example of the present invention.

FIG. 5 is a simplified diagram illustrating a global microwave control of qubits according to an example of the present invention.

FIG. 6 is a simplified diagram illustrating a local microwave control of qubits in combination with locally addressing laser beams according to an example of the present invention.

FIG. 7 is a simplified diagram illustrating global qubit control by a pair of lasers according to an example of the present invention.

FIG. 8 is a simplified diagram illustrating local qubit control by a pair of globally addressing lasers in combination with locally addressing laser beams to an example of the present invention.

FIG. 9 is a simplified diagram illustrating local qubit control by a pair of lasers according to an example of the present invention.

FIG. 10 is a simplified diagram illustrating controlled phase-flip gate according to examples of the present invention.

FIG. 11 is a simplified diagram illustrating control of connectivity of atoms in a cavity according to an example of the present invention.

FIG. 12 is a simplified illustrating a distributed quantum computing system according to an example of the present invention.

FIG. 13 is a simplified illustration of a distributed quantum computing system according to an example of the present invention.

### DETAILED DESCRIPTION OF EXAMPLES

The present invention relates generally to quantum computing techniques. In particular, the present invention provides a system and method including a nanofiber cavity QED system configured using an optical cable including a nanofiber region and a pair of reflectors and evanescently coupled atoms to the nanofiber region to enable an atom-cavity system for a quantum computing device. Merely by way of example, the invention can be applied to a variety of applications such as cryptography, drug discovery, optimization, machine learning and artificial intelligence, finance, weather forecasting, chemical, mechanical, electrical, civil, nuclear fusion and fission, economics, materials, and any other complex human or non-human matters.

As additional background, quantum computing is an advancing field that will revolutionize computing by harnessing the principles of quantum mechanics to perform computations that are intractable for classical computers. Various applications exist. Such applications include cryptography, drug discovery, optimization, machine learning and artificial intelligence, finance, weather forecasting, chemical, mechanical, electrical, civil, nuclear fusion and fission, economics, materials, and any other human or non-human matters. Quantum computing can be used to break many of the cryptographic codes that are currently in use. Quantum computing can simulate complex molecular interactions, which can help discover new drugs or improve existing ones. Quantum computing could dramatically speed up the development of new pharmaceuticals.

Additionally, many real-world problems, such as logistics or resource allocation, involve optimization of complex systems. Quantum computing can solve these problems exponentially faster than classical computers. Quantum computing can be used to train and optimize machine learning algorithms, which could lead to new breakthroughs in areas such as image and speech recognition, natural language processing, and robotics. Quantum computing could be used to solve optimization problems related to portfolio management, risk analysis, and pricing derivatives. Quantum computing can simulate quantum systems, which could help solve problems in materials science, condensed matter physics, and high-energy physics. Further details of our present system and related methods can be found throughout the present specification and more particularly below.

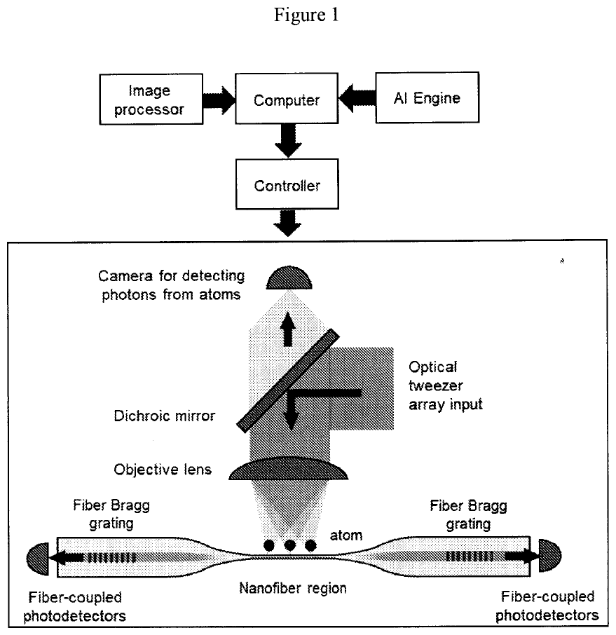

FIG. 1 is a simplified diagram illustrating a quantum computing cell device according to an example of the present invention. As shown, the diagram includes a device and related system. The device includes a nanofiber region, which is thinner in diameter. A plurality of atoms is disposed slightly above the surface of the nanofiber region. In an example, the atoms are localized about 200 to 400 nanometers above the nanofiber surface for a 400 to 600 nanometer nanofiber diameter, although there can be variations. In an example, each side of the nanofiber region is configured with a taper region that is connected to a fiber Bragg Grating structure. Each end of the fiber Bragg Grating structure is connected to the optical cable that has a photodetector device provided in a photon detection system.

In an example, the system has an imaging system. The imaging system has an image capturing device and a light source. The device also has a variety of optics including an objective lens and a dichroic mirror device configured between the image capturing device and the light source. The image capturing device includes a CMOS or charged coupled device camera including a pixel array.

In an example, the system also has a controller coupled to the imaging system and light source. The controller is also coupled to a computing device, artificial intelligence engine, and image processor. The controller can be any suitable controller device including a plurality of analog-to-digital/digital-to-analog converter devices configured to interface with a computer. As shown, the controller for controlling signals from a quantum computer device is a specialized electronic system designed to interface with the quantum computing system and manipulate the signals sent and received by the device. The controller plays a crucial role in quantum computing, as it is responsible for orchestrating the complex operations required to perform quantum algorithms and measurements.

In an example, the controller typically has several components, including input/output interfaces, digital signal processing circuits, and control logic. The input/output interfaces are used to communicate with the quantum device, receiving signals from the quantum device and sending control signals to the device. These signals are typically in the form of electrical, microwave, or radio frequency signals. The digital signal processing circuits are responsible for processing the signals received from the quantum device, applying corrections for errors and noise, and performing operations such as pulse shaping and timing. This requires specialized algorithms and processing techniques that are optimized for quantum computing applications. The control logic is responsible for coordinating the operations of the controller and the quantum device, determining the appropriate sequence of operations to perform quantum algorithms and measurements. The control logic is typically implemented using a combination of software and hardware, including field-programmable gate arrays (FPGAs) and custom application specific integrated circuits (ASICs).

In a preferred example, the system includes an optical tweezer that is a device that uses a focused laser beam to trap and manipulate microscopic objects, such as atoms and molecules. In an example, a basic principle behind an optical tweezer is that the laser beam exerts a force on the object that is proportional to the gradient of the intensity of the light. In the example of manipulating atoms, an optical tweezer typically involves a laser beam that is tightly focused to a diffraction-limited spot using a high numerical aperture objective lens. The laser beam is usually in the infrared or visible range and can be generated by a solid-state laser or a diode laser. When the laser beam at an appropriate wavelength is focused on an atom, it creates an attractive force that pulls the atom towards the center of the beam. This is known as optical trapping, or “optical tweezing.” The strength of the trapping force depends on the intensity of the laser beam and the polarizability of the atom. By manipulating the position and intensity of the laser beam, we can trap atoms at a fixed distance from the nanofiber surface owing to the interference between incoming tweezer beam and its scattering from the nanofiber.

In an example, the present invention provides a quantum computer cell system. In an example, the system has a fiber optical cable having a first end region and a second end region. The first end region has a first end, and the second end region having a second end. In an example, the fiber optical cable comprises a silicon dioxide material with dopant material entity distributed inside of a core region, including Germanium and others.

In an example, the system has a first fiber Bragg Grating configured on the first end region and a second fiber Bragg Grating configured on the second end region. In an example, a system has a nanofiber region configured from a center portion of the fiber optic cable and coupled between the first end region and the second end region. The nanofiber region has a transmission of 99% or greater. In an example, the nanofiber region has a diameter ranging from 300 nanometer to 1.5 micrometer. In an example, the nanofiber region ranges from 10 micrometer to 10 centimeter in length.

In an example, the system has a first taper region configured from a first portion of the nanofiber region within a vicinity of the first fiber Bragg Grating and a second taper region configured from a second portion of the nanofiber region within a vicinity of the second fiber Bragg Grating. In an example, the system has a cavity formed between the first fiber Bragg Grating and the second fiber Bragg Gratings including the taper regions and nanofiber region.

In an example, the system has a plurality of atoms comprising an alkali metal atom including a cesium and a rubidium, an alkaline-earth metal and an alkaline-earth-like atom including an ytterbium or a strontium and other laser-coolable atoms such that a number of the atoms range from one to 100,000 and are evanescently coupled to the nanofiber region.

In an example, the system has an imaging system characterized by a numerical aperture of 0.1 and greater, although there can be variations. In an example, the imaging system is configured to generate an optical tweezer array and to detect one or more photons from one or the plurality of atoms with a spatial resolution ranging from 400 nanometer and larger.

In an example, the photon detection system characterized by a collection efficiency of more than 99% from the nanofiber region to a fiber optic cable where photons emitted from one or more of the plurality of atoms trapped near the cavity are coupled to the fiber optical cable. In an example, the photons are collected using the photon detection system coupled to at least a first end or a second end of the fiber optical cable.

In an example, the imaging system comprises a first lens to an nth lens, where n is an integer greater than 1. In an example, the lens or lenses are configured to magnify an image ranging three to fifty times to capture the magnified image within a predetermined spectral range using array of pixels. The array of pixels can comprise at least one hundred by one hundred pixels to create a spatial resolution ranging from 0.5 micron to 2 micron over a spatial region of 0.1 by 0.1 millimeters and greater.

The imaging system is coupled to an image processing device in an example. The image processing device is configured to receive a stream of data comprising the captured image and configured to process the captured image into a gray scale image map, to threshold the gray scale image map and to output a binary representation of the captured image to identify one of more of the plurality of atoms.

In an example, the imaging system is configured to align the nanofiber region to the imaging system. In an example, the image processing device is configured to receive a stream of data comprising the captured image and configured to process the captured image into to identify a spatial location of a portion of the nanofiber region. In a preferred example, the image processing device is configured to provide feedback to change the spatial location of the objective lens and other lens to align the imaging system to the nanofiber region.

In an example, the imaging system comprising a laser light source configured a predetermined wavelength range. The laser light source is configured with a spatial light modulator configured with an objective lens to form a plurality of laser beams configured as the optical tweezer array to focus onto a selected portion of the nanofiber region. The laser light source is configured with a dichroic mirror to reflect or transmit a laser beam and traverse through an objective lens to focus onto a selected portion of the nanofiber region such that a portion of the laser beam is reflected back from the nanofiber region through the dichroic mirror to be imaged on an array of pixels. In an example, the laser beam is characterized by a single mode in frequency having a wavelength ranging from 400 nm to 2000 nm, among other wavelength ranges.

In an example, the laser light source is configured with a spatial light modulator configured with an objective lens to form a plurality of laser beams configured as the optical addressing array to focus onto a selected portion of the nanofiber region. A portion of the laser beam is reflected back through the dichroic mirror to be imaged on an array of pixels.

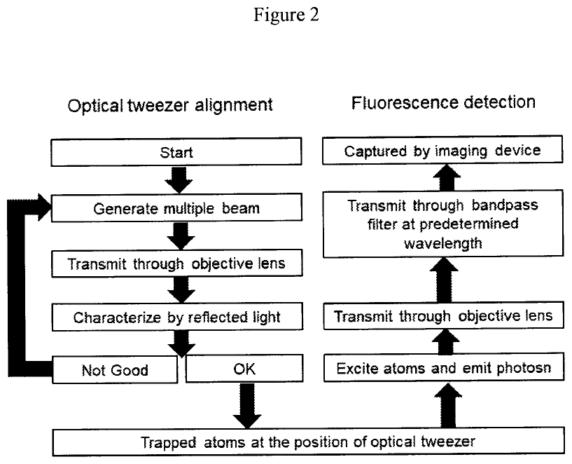

FIG. 2 is a simplified illustration of a method of operating a quantum computing cell device according to an example of the present invention. As shown, the method beings at start. The method generates a laser beam using a laser light source. The laser beam is subjected to a spatial light modulator to generate multiple light beams. The multiple beams are transmitted through an objective lens, which are focused to a nanofiber region. The multiple beams are reflected back in part to determine an alignment between the nanofiber region and the imaging system. If the alignment is not within a predetermined criterion, a relationship between the imaging system and nanofiber region is spatially adjusted to accommodate for any misalignment, including any imperfections on the objective lens. Once the relationship has been adjusted, the method repeats to determine whether the alignment meets the predetermined criteria.

In an example, the method then uses the light beams to trap atoms and then position the atoms on selected portions of the nanofiber region. Once the atoms have been positioned, the atoms are excited using the multiple laser beams. The excited atoms emit photons that are transmitted through the objective lens. The photons are transmitted through a band path filter at a predetermined wavelength. The transmitted photons are then captured using an imaging device, which is a camera assembly including a pixel array. Further details of the present method can be found throughout the present specification and more particularly below.

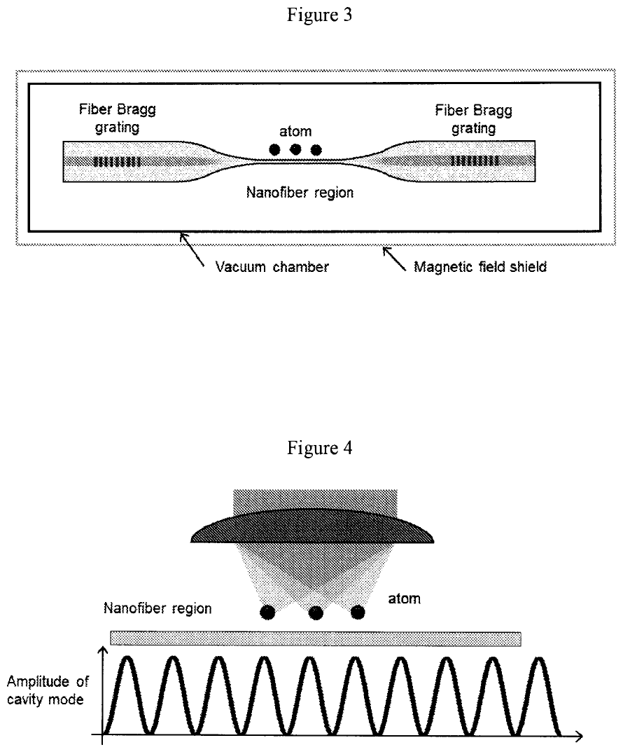

FIG. 3 is a simplified diagram of a vacuum chamber configured with a quantum computing cell device according to an example of the present invention. As shown a vacuum chamber is configured around a nanofiber cavity device. In an example, the vacuum chamber configured to maintain the nanofiber region in a predetermined vacuum environment, e.g., 10-10 Torr. In an example, the chamber is maintained at a predetermined temperature environment ranging from room temperature to 4 Kelvin, although there can be others. In an example, the chamber is substantially free from a magnetic field fluctuation that may interact with one or more of the plurality of atoms. Preferably, the magnetic field fluctuation from the surrounding is blocked from an interior of the vacuum chamber using a magnetic field shield device configured with the vacuum chamber. In an example, the plurality of atoms is cool down to a temperature of below 1 milli-Kelvin to near absolute zero by a magneto-optical trapping generated from a combination of a magnetic field gradient and a laser irradiation from three orthogonal spatial direction, and subsequent laser cooling with atoms trapped in the tweezer array where the motional degree-of-freedom is cool down to the ground state or closer to it.

FIG. 4 is a simplified diagram of an optical tweezer device configured to control spatial location relative to a standing-wave pattern of the cavity mode in a nanofiber region according to an example of the present invention. As shown, an amplitude of the cavity mode forms a standing-wave pattern between the pair of fiber Bragg Gratings including the nanofiber region. As shown, one or more atoms are configured to be coupled to a region within a vicinity of a surface of the nanofiber region. As shown, one or more atoms are disposed within a vicinity of an amplitude of the standing wave resonating between the Bragg Gratings. In operation, the optical tweezer device traps the atoms and dispenses individual atoms at the maximum amplitude of the standing wave. At the top of an amplitude region, atom-photon coupling is maximized for detection of the atoms that will be excited. The stronger atom photon coupling also facilitates a logic gate for reflection of photons with higher fidelity.

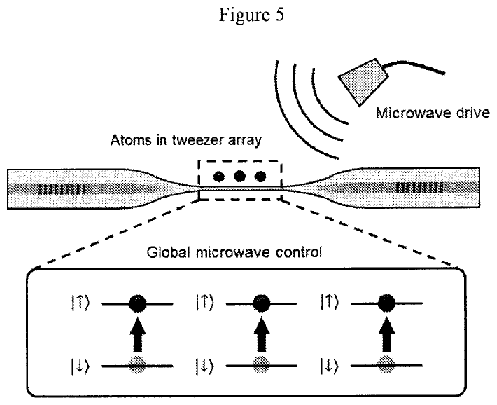

FIG. 5 is a simplified diagram illustrating a global microwave control of qubits according to an example of the present invention. In an example, the microwave radiation is subjected to all the trapped atoms near the nanofiber region. The microwave flips a qubit state from up to down or down to up, and other variations.

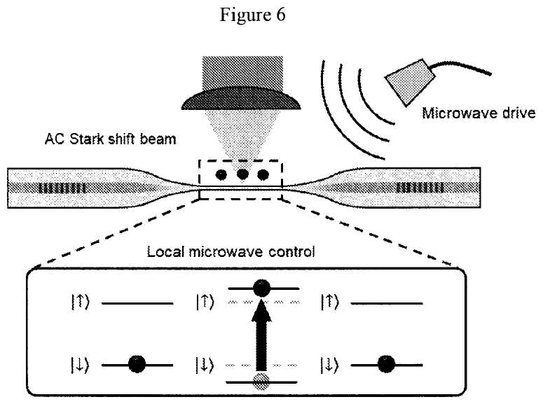

FIG. 6 is a simplified diagram illustrating a local microwave control of qubits according to an example of the present invention. In an example, the microwave is subjected to one or more atoms that have been selected using an optical addressing array to shift the resonance frequency of one or more atoms.

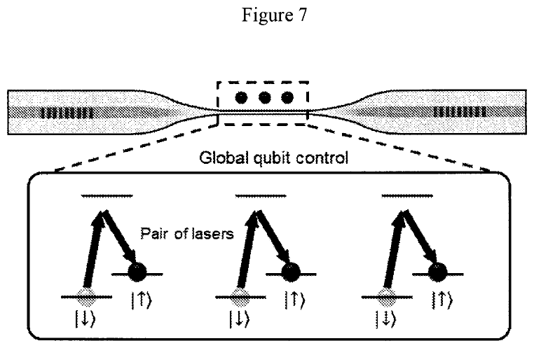

FIG. 7 is a simplified diagram illustrating global qubit control by a pair of lasers according to an example of the present invention. In an example, the pair of lasers is subjected to all the trapped atoms near the nanofiber region. The pair of lasers controls an arbitrary qubit state from up to down or down to up and other variations.

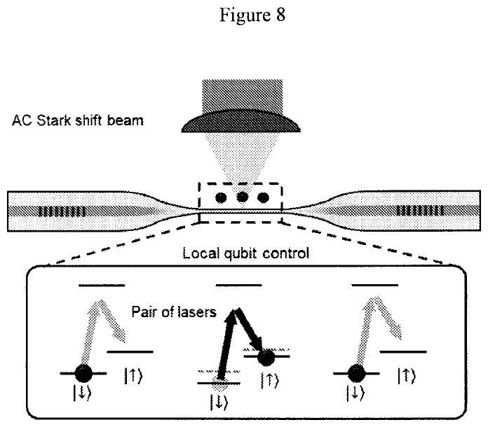

FIG. 8 is a simplified diagram illustrating a local qubit control with the combination of an optical addressing array and a pair of lasers according to an example of the present invention. In an example, the pair of lasers is subjected to one or more atoms that have been selected using an optical addressing array to shift the resonance frequency of one or more atoms.

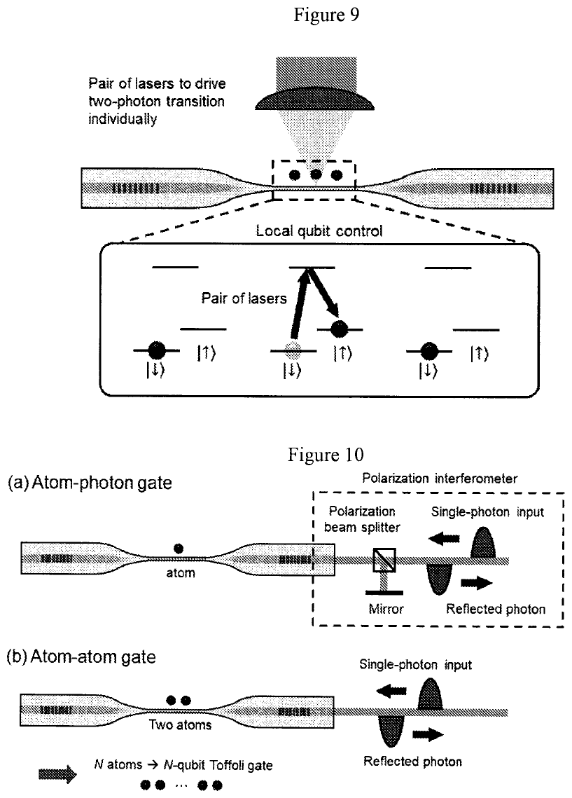

FIG. 9 is a simplified diagram illustrating local qubit control by a pair of lasers according to an example of the present invention. In an example, the pair of lasers from the optical addressing array select one or more atoms and controls its or their arbitrary qubit states from up to down or down to up and other variations.

FIG. 10 is a simplified diagram illustrating controlled phase-flip gate according to examples of the present invention (Ref. [1,2]). As shown, when an atom is coupled to a cavity, the resulting photon will be reflected from the fiber Bragg Grating. When the atom is not coupled to a cavity, a resulting photon enters the cavity, and then emits out of the cavity with the relative phase difference of 180 degree. As also shown, with two or more atoms (e.g., n atoms), if one of the n atoms is coupled to the cavity, a resulting photon will be reflected from the fiber Bragg Grating. When the atoms are not coupled to a cavity, a resulting photon enters the cavity, and then emits out of the cavity with the relative phase difference of 180 degree.

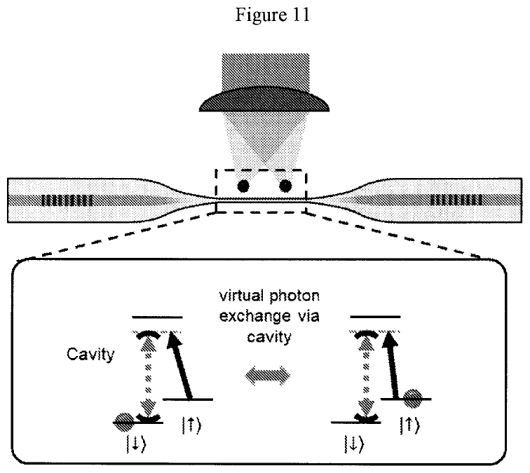

FIG. 11 is a simplified diagram illustrating cavity-mediated spin-spin interactions according to an example of the present invention (Ref. [3]). As shown, an optical addressing array is configured such that i-th atom emits a virtual photon into the cavity and flips the spin accordingly, and j-th atom absorbs the same virtual photon and flips the spin of j-th atom where i and j are integer number. This spin-spin interaction enables the control phase-flip gate by combining the single qubit control.

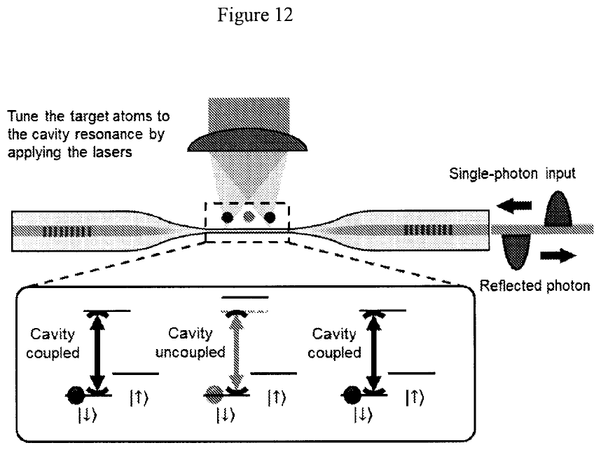

FIG. 12 is a simplified diagram illustrating control of connectivity of atoms in a cavity according to an example of the present invention. As shown, an optical addressing array is configured to selectively choose one or more atoms among a plurality of atoms that are coupled to the cavity.

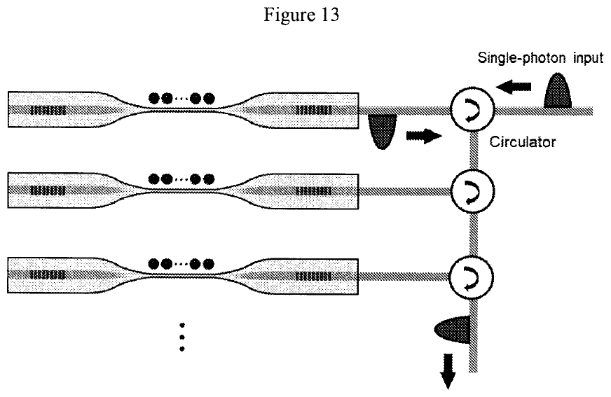

FIG. 13 is a simplified illustration of a distributed quantum computing system according to an example of the present invention. As shown, the system includes a plurality of nanofiber cavity QED systems each of which is coupled in serial configuration. Each of the nanofiber cavity QED systems is a separate quantum computer device. In operation, one of single photons is configured to traverse through each of the nanofiber cavity QED systems, as shown. Further details of the present techniques can be found throughout the present specification and more particularly below.

In an example, the present techniques have variations. In an example, each of the first fiber Bragg grating and the second fiber Bragg grating is configured with a reflectivity of a 99% and greater. In an example, the nanofiber region is characterized by a constant diameter within 90%. In an example, each of the first fiber Bragg grating and the second fiber Bragg grating comprises a plurality of refractive index modulation structures at the core of the optical fiber cable. The refractive index modulation structures are inscribed by an intensity pattern of an ultraviolet laser which is created by a diffraction of a laser beam at a phase-shift mask fabricated by an electron-beam lithography.

In an example, the system has one or more laser devices coupled to the first fiber Bragg Grating and/or the second fiber Bragg Grating and mounted on a silicon wafer configured to absorb infrared electromagnetic radiation. Each of the laser devices is configured to control a center frequency of each of the first fiber Bragg Grating and the second fiber Bragg Grating to independently adjust each reflectivity ranging from 98.0% to 99.999%.

In an example, a laser device is coupled to the nanofiber region. The laser device is configured to control a cavity resonance frequency to a transition frequency of a selected atom by changing the temperature of the nanofiber region.

In an example, a major axis of cavity-mode polarization is chosen to be parallel to an incident direction of the optical tweezer to maximize an atom-photon coupling. The cavity-mode polarization is characterized by an intensity of light scattering from the nanofiber region.

In an example, the optical tweezer array comprises an optical tweezer device configured to generate one or more optical tweezer spots such that the optical tweezer device is in spatial alignment to the nanofiber region and is stabilized with a feedback process by monitoring an optical signal derived from the nanofiber region. In an example, one or more of the plurality of atoms are trapped by using an optical tweezer device from the optical tweezer array, the optical tweezer device configured with a feedback process to receive an optical signal derived from the nanofiber region and/or fluorescence signals from the atoms for generation of uniform optical tweezer array at the distance of 100 nanometer to 1 micrometer from the nanofiber region.

In an example, the one or more of the plurality of atoms emit photons are configured to be captured by an imaging system. The one or more atoms are configured in a spatial orientation such that the imaging system captures a spatial image of the emitted photons from the one or more atoms.

In an example, the system has a laser device illuminating one or the plurality of atoms from three orthogonal spatial directions to reduce a temperature of atoms while imaging one or more of the atoms independent of an atom-cavity coupling. In an example, the laser device is characterized by an operating wavelength with >1 Terahertz difference from an atom-cavity resonance.

In an example, one or more of the plurality of atoms is configured to store a quantum state with a storage time ranging from 1 microsecond to greater. In an example, at least one of the plurality of atoms and a reflected photon from the cavity are configured to operate a controlled phase-flip gate. In an example, at least two of the plurality of atoms are configured to operate a controlled phase-flip gate by reflecting a single photon, and N atoms being configured to operate N-qubit Toffoli gate by reflecting a single photon.

In an example, the one or more of the plurality of atoms emit a plurality of photons configured to be collected at the nanofiber region and be transmitted to the optical fiber cable coupled to the nanofiber region.

In an example, the system has an optical filtering device coupled to the optical fiber cable. In an example, the optical filtering device is configured to couple photons from the atoms and remove additional photons not emitted from the atoms and/or derived from other laser devices and/or emitted from the material into the optical fiber cable.

In an example, the system has one or more single-photon detectors fiber coupled to at least the first end or the second end of the optical fiber cable. In an example, the system has a polarization analyzer device whereupon a state of a photonic qubit reflected from the cavity is diagnosed and projected. In an example, the system is one of a plurality of devices configured in a distributed system.

### REFERENCES

[1] L.-M. Duan and H. J. Kimble Phys. Rev. Lett. 92, 127902 (2004).
[2] L.-M. Duan, B. Wang, and H. J. Kimble Phys. Rev. A 72, 032333 (2005)
[3] C.-L. Hung, A. Gonzalez-Tudela, J. I. Cirac and H. J. Kimble, Proceeding of National Academy of Science, 113, E4946 (2016).

While the above is a full description of the specific examples, various modifications, alternative constructions, and equivalents may be used. As an example, the device can include any combination of elements described above, as well as outside of the present specification. Additionally, the terms first, second, third, and final do not imply order in one or more of the present examples. Therefore, the above description and illustrations should not be taken as limiting the scope of the present invention which is defined by the appended claims.

1. A quantum computer cell system, the system comprising:
a fiber optical cable having a first end region and a second end region, the first end region having a first end, and the second end region having a second end, the fiber optical cable comprising silicon dioxide material with dopant material entity distributed inside of a core region;
a first fiber Bragg Grating configured on the first end region;
a second fiber Bragg Grating configured on the second end region;
a nanofiber region configured from a center portion of the fiber optic cable and coupled between the first end region and the second end region, the nanofiber region having a transmission of 99% and greater, the nanofiber region having a diameter ranging from 300 nanometer to 1.5 micrometer, the nanofiber region ranging from 10 micrometer to 10 centimeter in length;
a first taper region configured from a first portion of the nanofiber region within a vicinity of the first fiber Bragg Grating;
a second taper region configured from a second portion of the nanofiber region within a vicinity of the second fiber Bragg Grating;
a cavity formed between the first fiber Bragg Grating and the second fiber Bragg Gratings including the taper regions and the nanofiber region;
a plurality of atoms comprising an alkali metal atom including a cesium and a rubidium, an alkaline-earth metal and an alkaline-earth-like atom including an ytterbium and a strontium and other laser coolable atoms such that a number of the atoms range from one to 100,000 and are evanescently coupled to the nanofiber region between the first fiber Bragg grating and the second fiber Bragg grating; and
an imaging system characterized by a numerical aperture of 0.1 and greater, the imaging system configured to generate an optical tweezer array and optical addressing array and to detect one or more photons from one or the plurality of atoms with a spatial resolution ranging from 400 nanometer and larger.

2. The system of claim 1 further comprising a photon detection system characterized by a collection efficiency of more than 99% from the nanofiber region to a fiber optic cable configured by photons emitted from one or more of the plurality of atoms trapped near the cavity coupled to the fiber optical cable such that the photons are collected using the photon detection system coupled to at least a first end or a second end of the fiber optical cable.

3. The system of claim 1 wherein the imaging system comprising a first lens to an nth lens, where n is an integer greater than 1, configured to magnify an image ranging three to fifty times to capture the magnified image within a predetermined spectral range using array of pixels configured by at least one hundred by one hundred pixels and create a spatial resolution of ranging from 0.5 micron to 2 micron over a spatial region of ranging from 0.1 by 0.1 millimeters to greater.

4. The system of claim 3 wherein the imaging system is coupled to an image processing device, the image processing device being configured to receive a stream of data comprising the captured image and configured to process the captured image into a gray scale image map to threshold the gray scale image map to output a binary representation of the captured image to identify one of more of the plurality of atoms.

5. The system of claim 3 wherein the imaging system is coupled to an image processing device, the image processing device being configured to receive a stream of data comprising the captured image and configured to process the captured image into to identify a spatial location of a portion of the nanofiber region; and configured to provide feedback to change the spatial location of one or more lens in the imaging system to align the imaging system to the nanofiber region.

6. The system of claim 1 wherein the imaging system comprising a laser light source configured a predetermined wavelength range, the laser light source is configured with a dichroic mirror to reflect or transmit a laser beam and traverse through an objective lens to focus onto a selected portion of the nanofiber region configure as the optical tweezer and the optical addressing beam such that a portion of the laser beam is reflected back from the nanofiber region through the dichroic mirror to be imaged on an array of pixels on the camera. The light source is a single-mode laser having a wavelength ranging from 400 nm to 2000 nm.

7. The system of claim 1 wherein the imaging system comprising a laser light source configured a predetermined wavelength range, the laser light source is configured with a spatial light modulator configured with an objective lens to form a plurality of laser beams 3 configured as the optical tweezer array and the optical addressing array to focus onto a selected portion of the nanofiber region such that a portion of the laser beam is reflected back from the nanofiber region through the dichroic mirror to be imaged on an array of pixels on the camera.

8. The system of claim 1 further comprising a vacuum chamber configured to maintain the nanofiber region in a predetermined vacuum environment, a predetermined temperature environment ranging from room temperature to 4 Kelvin.

9. The system of claim 8 wherein the magnetic field fluctuation outside of the vacuum chamber is blocked from an interior using a magnetic field shield device such that the interior of the vacuum chamber is substantially free from a magnetic field fluctuation of outside environment that may interact with one or more of the plurality of atoms.

10. The system of claim 1 wherein each of the first fiber Bragg grating and the second fiber Bragg grating is configured with a reflectivity of 98.0% and greater.

11. The system of claim 1 wherein the nanofiber region is characterized by a constant diameter within 90% and greater from a first portion of the nanofiber region to a second portion of the nanofiber region.

12. The system of claim 1 wherein each of the first fiber Bragg grating and the second fiber Bragg grating comprises a plurality of refractive index modulation structures at the core of the optical fiber cable, the refractive index modulation structures being inscribed by an intensity pattern of an ultraviolet laser which is created by a diffraction of a laser beam at a phase-shift mask fabricated by an electron-beam lithography.

13. The system of claim 1 further comprising one or more laser devices coupled to the first fiber Bragg Grating and/or the second fiber Bragg Grating and mounted on a silicon wafer configured to absorb infrared electromagnetic radiation, each of the laser devices is configured to control a center frequency of each of the first fiber Bragg Grating and the second fiber Bragg Grating to independently adjust each reflectivity ranging from 98.0% to 99.999%.

14. The system of claim 1 further comprising a laser device coupled to the nanofiber region, the laser device being configured to control a cavity resonance frequency to a transition frequency of a selected atom and the plurality of atoms by changing a temperature of the nanofiber region.

15. The system of claim 1 wherein the cavity is characterized by a major axis of cavity-mode polarization that is parallel to an incident direction of the optical tweezer to maximize an atom-photon coupling from a first level to a second level, the major axis of cavity-mode polarization having a direction monitored by an intensity of light scattering from the nanofiber region.

16. The system of claim 1 wherein the cavity is maintained in a vacuum environment and the plurality of atoms are cool down to a temperature of below 1 milli-Kelvin to near absolute zero by a magneto-optical trapping generated from a combination of a magnetic field gradient and a laser irradiation from three orthogonal spatial direction, and subsequent laser cooling with atoms trapped in the tweezer array where the motional degree-of-freedom is cool down to the ground state or closer to it.

17. The system of claim 1 wherein the optical tweezer array comprises an optical tweezer device configured to generate one or more optical tweezer spots such that the optical tweezer device is in spatial alignment to the nanofiber region and is stabilized with a feedback process by monitoring an optical signal derived from the nanofiber region.

18. The system of claim 17 wherein one or more of the plurality of atoms are trapped by using an optical tweezer device from the optical tweezer array, and the optical tweezer device is configured with feedback process to receive fluorescence signals from the atoms for generation of uniform optical tweezer array at the distance of 100 nanometer to 1 micrometer from the nanofiber region.

19. The system of claim 1 wherein the optical addressing array comprises an optical addressing device configured to generate one or more optical beam spots such that the optical addressing device is in spatial alignment to the nanofiber region and is stabilized with a feedback process by monitoring an optical signal derived from the nanofiber region.

20. The system of claim 1 wherein the one or more of the plurality of atoms emit photons configured to be captured by an imaging system, the one or more atoms being configured in a spatial orientation such that the imaging system captures a spatial image of the emitted photons from the one or more atoms.

21. The system of claim 1 further comprising a laser device illuminating one or more the plurality of atoms from three orthogonal spatial directions to reduce a temperature of atom while imaging one or more of the atoms independent of an atom-cavity coupling, the laser device being characterized by an operating wavelength with >1 Terahertz difference from an atom-cavity resonance.

22. The system of claim 1 wherein one or more of the plurality of atoms is configured to store a quantum state with a storage time ranging from 1 microsecond to greater.

23. The system of claim 1 wherein at least one of the plurality of atoms and a reflected photon from the cavity are configured to operate a controlled phase-flip gate.

24. The system of claim 1 wherein at least two of the plurality of atoms are configured to operate a controlled phase-flip gate by reflecting a single photon, and N atoms being configured to operate N-qubit Toffoli gate by reflecting a single photon where N is integer and larger than 3.

25. The system of claim 1 wherein at least two of the plurality of atoms are configured to operate spin-spin interactions including the controlled phase-flip gate by exchanging the virtual photons through the cavity (Ref. [3]).

26. The system of claim 1 wherein one or more of the plurality of atoms emit a plurality of photons configured to be collected at the nanofiber region and be transmitted to the optical fiber cable coupled to the nanofiber region.

27. The system of claim 1 further comprising an optical filtering device coupled to the optical fiber cable, the optical filtering device being configured to couple photons from the atoms and remove additional photons not emitted from the atoms and derived from other laser devices and emission from the material into the optical fiber cable.

28. The system of claim 1 further comprising one or more single-photon detectors fiber coupled to at least the first end or the second end of the optical fiber cable.

29. The system of claim 1 further comprising a polarization analyzer device whereupon a state of a photonic qubit reflected from the cavity is diagnosed and projected.

30. The system of claim 1 wherein the system is one of a plurality of devices configured in a distributed system.
